(19) United States
(12) Patent Application Publication
(10) Pub. No.: US 2026/0048426 A1
(43) Pub. Date: Feb. 19, 2026

(54) PREPARATION METHOD OF LAWN BRICK CAPABLE OF SOLIDIFYING AND STABILIZING LEAD-CONTAMINATED SOIL

(71) Applicant: Institute of Land Engineering and Technology, Shaanxi Provincial Land Engineering Construction Group, Xi'an (CN)

(72) Inventors: Luyao WANG, Xi’an (CN); Lulu ZHANG, Xi’an (CN); Biao PENG, Xi’an (CN); Yang ZHANG, Xi’an (CN); Xiao XIE, Xi’an (CN); Jing WANG, Xi’an (CN); Jianfeng Ll, Xi’an (CN); Chao GUO, Xi’an (CN); Siqi LIU, Xi’an (CN); Li QI, Xi’an (CN); Wen SUN, Xi’an (CN)

(73) Assignee: Institute of Land Engineering and Technology, Shaanxi Provincial Land Engineering Construction Group, Xi'an (CN)

(21) Appl. No.: 19/250,099

(22) Filed: Jun. 26, 2025

Related U.S. Application Data
(63) Continuation of application No. PCT/CN2023/130081, filed on Nov. 7, 2023.

(30) Foreign Application Priority Data
May 16, 2023 (CN) 202310549570.5

(51) Int. Cl. B09C 1/08; B09B 3/21; B09B 101/90

(52) U.S. Cl. CPC B09C 1/08; B09B 3/21; B09B 2101/90

(57) ABSTRACT

A preparation method of lawn bricks capable of solidifying and stabilizing lead-contaminated soil includes: preparing carbonized bagasse, grinding and mixing the carbonized bagasse and potassium carbonate in a mortar, heating the resulting mixture to 600-650° C., and maintaining for 2-3 hours; fully mixing the carbonized and treated bagasse, heavily-lead-contaminated soil, construction waste and fly ash; then adding a treated sodium silicate solution and stirring, and reacting under ultrasonic conditions; and performing grouting and compacting to obtain a homogeneous green brick, and curing same to obtain a lawn brick. The bagasse is taken as a raw material, and is carbonized and then mixed with the pre-treated heavily-Pb-contaminated soil, construction waste and fly ash, and under an action of alkali excitation and ultrasonic assistance, the resulting mixture is cured to form the lawn brick, such that Pb (II) in the Pb-contaminated soil is not migrated and converted any more.

### 1. CROSS REFERENCE TO RELATED APPLICATION

This application is a continuation of International Application No. PCT/CN2023/130081, filed on Nov. 7, 2023, which claims priority to Chinese Patent Application No. 202310549570.5, titled “METHOD FOR PREPARATION LAWN BRICK CAPABLE OF SOLIDIFYING AND STABILIZING LEAD-CONTAMINATED SOIL” and filed to the China National Intellectual Property Administration on May 16, 2023, the entire contents of which are incorporated herein by reference.

### 2. TECHNICAL FIELD

The present disclosure generally relates to the field of lead-contaminated soil solidification technologies, and especially relates to a preparation method of lawn bricks capable of solidifying and stabilizing lead-contaminated soil.

### 3. DESCRIPTION OF RELATED ART

Remediation of soil Heavy Metal Pollution generally starts from two ideas: one is to reduce a total amount of heavy metals in the soil, and the other is to control activity of heavy metals in the soil and reduce their migration into food chains. However, most conventional technological ways are difficult to economically and efficiently reduce the total amount of heavy metals in the soil. In order to effectively control an impact of heavy metals on agricultural product safety and human health, inhibiting, reducing or shielding a biological activity (i.e. bioavailability) of heavy metals will be a highly effective way. At present, solidification stabilization methods that are commonly used include a cement solidification stabilization method, a lime solidification stabilization method, a chemical solidification stabilization method, a plastic material solidification stabilization method, a self-bonding solidification stabilization method and a geological polymer solidification stabilization method, etc. The above methods each have their own advantages and disadvantages, among which both the cement solidification stabilization method and the lime solidification stabilization method have higher leaching rates, larger capacity expansion of solidified forms and a poor resistance to acidity and erosion thereof; a poor aging resistance, a complex operation and a high cost are occurred in the plastic material solidification stabilization method, and a narrow application scope is occurred in the self-bonding solidification method.

At present, research only focuses on solidification and stabilization effects of artificially added powdered heavy metal reagents or slag with heavy metals by using metakaolin or fly ash as raw materials, and there is little research on the solidification and stabilization of heavy metal soils. In addition, whether it is used for geological landfilling or building materials, the solidified body needs to have a sufficient strength to withstand a certain pressure thereof. Generally, a requirement for solid waste landfilling is around 5 MPa, and a requirement for building materials is above 10 MPa. Currently, most researches resulting on solidification stabilization methods only meet the standards for solid waste landfilling, rather than achieving further resource utilization of polluted soil.

### SUMMARY

The technical problems to be solved: in view of the shortcomings of the related art, the present disclosure provides a preparation method of lawn bricks capable of solidifying and stabilizing lead-contaminated soil which can overcome the problems in the related art.

A preparation method of lawn bricks capable of solidifying and stabilizing lead-contaminated soil according to an embodiment of the present disclosure includes:
preparing carbonized bagasse;
mixing the carbonized bagasse, heavily-lead-contaminated soil,
construction waste and fly ash, adding a sodium silicate solution thereto and stirring, and then reacting under ultrasonic conditions to obtain a slurry; and
injecting the slurry into a mold for curing, to obtain the lawn brick that can solidify and stabilize the lead-contaminated soil thereof.

Wherein the step of preparing carbonized bagasse includes: grinding and mixing the carbonized bagasse and potassium carbonate, heating the resulting mixture to 600-650° C. and maintaining for 2-3 hours, and then soaking in hydrochloric acid, washing it with deionized water until the aqueous solution is neutral, and drying it for a later use.

Wherein a weight ratio of the carbonized bagasse to the potassium carbonate is 1:1.

Wherein before the heavily-lead-contaminated soil is used as the raw material, the heavily-lead-contaminated soil is crushed and sieved through a 2-2.5 mm sieve, and before the construction waste is used as the raw material, the construction waste is crushed into particles with a diameter of 0.2-2.5 mm.

Wherein the sodium silicate solution is adjusted to a modulus of 0.5 by using NaOH.

Wherein the ultrasonic conditions are achieved by inserting an ultrasonic vibration rod into the resulting mixture that has been stirred, a power of the ultrasonic vibration rod set as 200-400w, and reacting for 30-35 minutes under an ultrasound action thereof.

Wherein during injecting the slurry into the mold, when a volume of the slurry that has been injected is one-third of a volume of the mold of the lawn brick, performing compacting on the slurry that has been injected, and then the slurry is poured into the mold and compacted again to obtain a homogeneous green brick.

Wherein the step of curing the homogeneous green brick is to seal the mold that has been filled with the slurry and compacted through a cling film, and then placed at a constant temperature of 40° C. for curing for 24-48 hours.

Wherein the step of curing the homogeneous green brick further includes: removing the brick from the mold and continue curing for 20 days at a temperature greater than 15° C. to maintain moisture thereof; when the temperature is less than 15° C., placing into a curing box or taking heat preservation measures thereof.

In a second aspect, a lawn brick capable of solidifying and stabilizing lead-contaminated soil according to an embodiment of the present disclosure is provided, wherein the lawn brick is prepared using raw materials in the following weight ratios:

3 parts of carbonized bagasse, 30-35 parts of heavily-lead-contaminated soil, 5-10 parts of construction waste, 54-60 parts of fly ash, and 50-55 parts of sodium silicate.

Compared with the related art, the present disclosure provides the advantages as below: the present disclosure provides the preparation method of lawn bricks capable of solidifying and stabilizing lead-contaminated soil that the bagasse is used as raw material, which is carbonized and mixed with pre-treated heavy Pb contaminated soil, construction waste and fly ash. Under an action of alkali stimulation and ultrasound assistance, further maintenance measures are taken to form lawn bricks, so that Pb (II) inside the Pb contaminated soil is no longer migrated and transformed, resulting in minimizing environmental negative effects thereof. At the same time, it can achieve resource utilization and is suitable for industrial production.

### BRIEF DESCRIPTION OF THE DRAWINGS

FIG. 1 is a scanning electron microscope (SEM) image of a lawn brick prepared by the present disclosure.

FIG. 2 is an energy spectrum (SEM-EDS) image of the lawn brick prepared by the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described embodiments of the present disclosure, all other embodiments obtained by one of ordinary skill in the related art on the premise of no creative work are within the protection scope of the present disclosure.

A preparation method of lawn bricks capable of solidifying and stabilizing lead-contaminated soil according to an embodiment of the present disclosure includes:
preparing carbonized bagasse; wherein the step of preparing carbonized bagasse includes: grinding and mixing the carbonized bagasse and potassium carbonate, heating the resulting mixture to 600-650° C. and maintaining for 2-3 hours, and then soaking in hydrochloric acid, washing it with deionized water until the aqueous solution is neutral, and drying it for a later use.

Mixing the carbonized bagasse, heavily-lead-contaminated soil, construction waste and fly ash, adding a sodium silicate solution thereto and stirring, and then reacting under ultrasonic conditions to obtain a slurry; wherein before the heavily-lead-contaminated soil is used as the raw material, the heavily-lead-contaminated soil is crushed and sieved through a 2-2.5 mm sieve, and before the construction waste is used as the raw material, the construction waste is crushed into particles with a diameter of 0.2-2.5 mm, and the sodium silicate solution is adjusted to a modulus of 0.5 by using NaOH. The ultrasonic conditions are achieved by inserting an ultrasonic vibration rod into the resulting mixture that has been stirred, a power of the ultrasonic vibration rod set as 200-400w, and reacting for 30-35 minutes under an ultrasound action thereof.

Injecting the slurry into a mold for curing, to obtain the lawn brick that can solidify and stabilize the lead-contaminated soil thereof. Wherein during injecting the slurry into the mold, when a volume of the slurry that has been injected is one-third of a volume of the mold of the lawn brick, performing compacting on the slurry that has been injected, and then the slurry is poured into the mold and compacted again to obtain a homogeneous green brick. The step of curing the homogeneous green brick is to seal the mold that has been filled with the slurry and compacted through a cling film, and then placed at a constant temperature of 40° C. for curing for 24-48 hours.

### A First Embodiment

Step S1: placing 3 parts of bagasse that have been cleaned and dried in a drying oven at a temperature of 105° C. for 8 hours into a crucible, and then placing the crucible in a tubular atmosphere furnace and heating the crucible up to a temperature of 400° C. at a rate of 15° C./min, followed by continuous heat preservation for 2 hours. Taking out the crucible and then grinding the carbonized bagasse and 3 parts of potassium carbonate in a mortar for 10 minutes to thoroughly mix, and continuing to place the crucible in the tubular atmosphere furnace, to heat the crucible to 600° C. and continue for 2 hours. Taking out the carbonized bagasse and soaking the carbonized bagasse in 1 mol/L hydrochloric acid for 30 minutes, then washing it with deionized water until the aqueous solution is neutral, and finally drying it in a drying oven at 105° C. for 8 hours.

Step S2: crushing 30 heavily-lead-contaminated soils by using a continuous grinder and sieving the 30 heavily-lead-contaminated soils through a 2 mm sieve; crushing 10 parts of construction waste (clay bricks, cement blocks etc.) through a hammer crusher, with a particle size of approximately 0.2˜2.5 mm.

Step S3: adding NaOH to adjust a modulus of the sodium silicate solution to 0.5.

Step S4: mixing the carbonized bagasse that is treated in the step S1, the heavily-lead-contaminated soil and the construction waste that are treated in the step S2, and 54 parts of fly ash in a mixer for stirring for 3-8 minutes to ensure to be mixed thoroughly thereof. And then adding 50 parts of the sodium silicate solution that is treated in the step S3 and continuing stirring for 15 minutes, at the same time, inserting an ultrasonic vibration rod therein, wherein a power of the ultrasonic vibration rod is set to around 300W. Reacting for 30 minutes under an action of ultrasound, to obtain a slurry.

Step S5: transferring the slurry of the step S4 to the mold of the lawn brick, and when a volume of the slurry reaches one-third of a volume of the mold, fixing it on a vibration table for being compacted for 20 minutes to eliminate bubbles in a lower layer thereof, and then filling the mold with the slurry and continuing to fix it on the vibration table and compact it for 30 minutes, to obtain a homogeneous green brick.

Step S6: sealing the mold containing the slurry through a polyethylene film and placing into a constant temperature curing box that is pre-heated at a temperature of 40° C. for being cured for 24-48 hours.

Step S7: when the bricks in the mold will not deform upon contact, the bricks will be removed from the mold and covered with a damp cloth in an open space with a temperature greater than 15° C. for 20 days of continuous curing. Daily, the damp cloth can be evenly sprayed with warm water to keep the damp cloth moist. If the temperature is less than 15° C., it is recommended to place the bricks in a curing box or take heat preservation measures. Finally, the lawn brick that can solidify and stabilize lead-contaminated soil is obtained.

A compressive strength test is conducted on the lawn bricks that are prepared according to the above embodiment of the present disclosure, which is 21.32 MPa. A total lead concentration in the leachate is measured to be 194.4 μg/L through performing a leaching toxicity test thereof, which is much lower than a Pb concentration limit of 5 mg/L that is specified in the «Identification Standards for Hazardous Waste-Leaching Toxicity Identification> (GB5085.3-2007).

### A Second Embodiment

Step S1: placing 3 parts of bagasse that have been cleaned and dried in a drying oven at a temperature of 105° C. for 8 hours into a crucible, and then placing the crucible in a tubular atmosphere furnace and heating the crucible up to a temperature of 400° C. at a rate of 15° C./min, followed by continuous heat preservation for 2 hours. Taking out the crucible and then grinding the carbonized bagasse and 3 parts of potassium carbonate in a mortar for 10 minutes to thoroughly mix, and continuing to place the crucible in the tubular atmosphere furnace, to heat the crucible to 600° C. and continue for 2 hours. Taking out the carbonized bagasse and soaking the carbonized bagasse in 1 mol/L hydrochloric acid for 30 minutes, then washing it with deionized water until the aqueous solution is neutral, and finally drying it in a drying oven at 105° C. for 8 hours.

Step S2: crushing 35 heavily-lead-contaminated soils by using a continuous grinder and sieving the 35 heavily-lead-contaminated soils through a 2.5 mm sieve; crushing 5 parts of construction waste (clay bricks, cement blocks etc.) through a hammer crusher, with a particle size of approximately 0.2˜2.5 mm.

Step S3: adding NaOH to adjust a modulus of the sodium silicate solution to 0.5.

Step S4: mixing the carbonized bagasse that is treated in the step S1, the heavily-lead-contaminated soil and the construction waste that are treated in the step S2, and 54 parts of fly ash in a mixer for stirring for 3-8 minutes to ensure to be mixed thoroughly thereof. And then adding 55 parts of the sodium silicate solution that is treated in the step S3 and continuing stirring for 45 minutes, at the same time, inserting an ultrasonic vibration rod therein, wherein a power of the ultrasonic vibration rod is set to around 300W. Reacting for 30 minutes under an action of ultrasound, to obtain a slurry.

Step S5: transferring the slurry of the step S4 to the mold of the lawn brick, and when a volume of the slurry reaches one-third of a volume of the mold, fixing it on a vibration table for being compacted for 20 minutes to eliminate bubbles in a lower layer thereof, and then filling the mold with the slurry and continuing to fix it on the vibration table and compact it for 30 minutes, to obtain a homogeneous green brick.

Step S6: sealing the mold containing the slurry through a polyethylene film and placing into a constant temperature curing box that is pre-heated at a temperature of 40° C. for being cured for 24-48 hours.

Step S7: when the bricks in the mold will not deform upon contact, the bricks will be removed from the mold and covered with a damp cloth in an open space with a temperature greater than 15° C. for 20 days of continuous curing. Daily, the damp cloth can be evenly sprayed with warm water to keep the damp cloth moist. If the temperature is less than 15° C., it is recommended to place the bricks in a curing box or take heat preservation measures. Finally, the lawn brick that can solidify and stabilize lead-contaminated soil is obtained.

A compressive strength test is conducted on the lawn bricks that are prepared according to the above embodiment of the present disclosure, which is 19.95 MPa. A total lead concentration in the leachate is measured to be 301.8 μg/L through performing a leaching toxicity test thereof, which is much lower than a Pb concentration limit of 5 mg/L that is specified in the <<Identification Standards for Hazardous Waste-Leaching Toxicity Identification>> (GB5085.3-2007).

### A Third Embodiment

Step S1: placing 3 parts of bagasse that have been cleaned and dried in a drying oven at a temperature of 105° C. for 8 hours into a crucible, and then placing the crucible in a tubular atmosphere furnace and heating the crucible up to a temperature of 400° C. at a rate of 15° C./min, followed by continuous heat preservation for 2 hours. Taking out the crucible and then grinding the carbonized bagasse and 3 parts of potassium carbonate in a mortar for 10 minutes to thoroughly mix, and continuing to place the crucible in the tubular atmosphere furnace, to heat the crucible to 600° C. and continue for 2 hours. Taking out the carbonized bagasse and soaking the carbonized bagasse in 1 mol/L hydrochloric acid for 30 minutes, then washing it with deionized water until the aqueous solution is neutral, and finally drying it in a drying oven at 105° C. for 8 hours.

Step S2: crushing 30 heavily-lead-contaminated soils by using a continuous grinder and sieving the 30 heavily-lead-contaminated soils through a 2 mm sieve; crushing 10 parts of construction waste (clay bricks, cement blocks etc.) through a hammer crusher, with a particle size of approximately 0.2˜2.5 mm.

Step S3: adding NaOH to adjust a modulus of the sodium silicate solution to 0.5.

Step S4: mixing the carbonized bagasse that is treated in the step S1, the heavily-lead-contaminated soil and the construction waste that are treated in the step S2, and 60 parts of fly ash in a mixer for stirring for 3-8 minutes to ensure to be mixed thoroughly thereof. And then adding 50 parts of the sodium silicate solution that is treated in the step S3 and continuing stirring for 45 minutes, at the same time, inserting an ultrasonic vibration rod therein, wherein a power of the ultrasonic vibration rod is set to around 300W. Reacting for 30 minutes under an action of ultrasound, to obtain a slurry.

Step S5: transferring the slurry of the step S4 to the mold of the lawn brick, and when a volume of the slurry reaches one-third of a volume of the mold, fixing it on a vibration table for being compacted for 20 minutes to eliminate bubbles in a lower layer thereof, and then filling the mold with the slurry and continuing to fix it on the vibration table and compact it for 30 minutes, to obtain a homogeneous green brick.

Step S6: sealing the mold containing the slurry through a polyethylene film and placing into a constant temperature curing box that is pre-heated at a temperature of 40° C. for being cured for 24-48 hours.

Step S7: when the bricks in the mold will not deform upon contact, the bricks will be removed from the mold and covered with a damp cloth in an open space with a temperature greater than 15° C. for 20 days of continuous curing. Daily, the damp cloth can be evenly sprayed with warm water to keep the damp cloth moist. If the temperature is less than 15° C., it is recommended to place the bricks in a curing box or take heat preservation measures. Finally, the lawn brick that can solidify and stabilize lead-contaminated soil is obtained.

A compressive strength test is conducted on the lawn bricks that are prepared according to the above embodiment of the present disclosure, which is 19.44 MPa. A total lead concentration in the leachate is measured to be 1248.4 μg/L through performing a leaching toxicity test thereof, which is much lower than a Pb concentration limit of 5 mg/L that is specified in the dentification Standards for Hazardous Waste-Leaching Toxicity Identification (GB5085.3-2007).

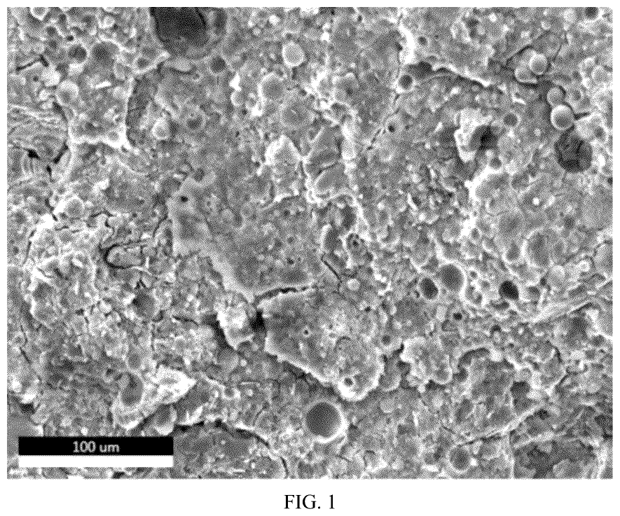

FIG. 1 is a scanning electron microscope (SEM) image of a lawn brick prepared by the present disclosure. As shown in FIG. 1, it can be clearly seen that the heavily-metal-contaminated loess and other materials such as the fly ash generate a dense geopolymer gel (amorphous aluminosilicate gel) after being performed a geopolymerization reaction thereof, wherein an apparent morphology presents a non-completely uniform amorphous form with a dense structure thereof.

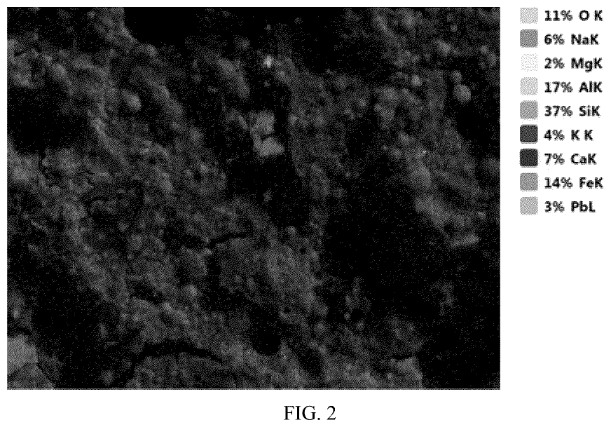

FIG. 2 is an energy spectrum (SEM-EDS) image of the lawn brick prepared by the present disclosure. As shown in FIG. 1, there are 37% Si, 17% Al, 14% Fe, 11% 0, 7% Ca, 6% Na, 4% K, 3% Pb and 2% Mg in the lawn bricks, wherein silicon aluminum products and the Pb are evenly distributed thereof.

Prior to the reaction in the embodiment of the present disclosure, an unstable state of the Pb in Pb contaminated soil is accounted for 96.24%. Through the reaction process of the embodiment of the present disclosure, it can be found that the unstable state of the Pb in the soil is transformed into a stable state of organic matter bound state and residual state. The exchangeable state Pb is decreased by 32.48 percentage points, while the residual state Pb is increased by 37.05 percentage points. Based on changes of the Pb morphology before and after the reaction, it can be concluded that Pb has been solidified and stabilized through the solidification stabilization reaction according to the embodiment of the present disclosure.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. A preparation method of lawn bricks capable of solidifying and stabilizing lead-contaminated soil comprising:
preparing carbonized bagasse;
mixing the carbonized bagasse, heavily-lead-contaminated soil, construction waste and fly ash, adding a sodium silicate solution thereto and stirring, and then reacting under ultrasonic conditions to obtain a slurry; and
injecting the slurry into a mold for curing, to obtain the lawn brick that can solidify and stabilize the lead-contaminated soil thereof.

2. The preparation method as claimed in claim 1, wherein the step of preparing carbonized bagasse comprises: grinding and mixing the carbonized bagasse and potassium carbonate, heating the resulting mixture to 600-650° C. and maintaining for 2-3 hours, and then soaking in hydrochloric acid, washing it with deionized water until the aqueous solution is neutral, and drying it for a later use.

3. The preparation method as claimed in claim 2, wherein a weight ratio of the carbonized bagasse to the potassium carbonate is 1:1.

4. The preparation method as claimed in claim 1, wherein before the heavily-lead-contaminated soil is used as the raw material, the heavily-lead-contaminated soil is crushed and sieved through a 2-2.5 mm sieve, and before the construction waste is used as the raw material, the construction waste is crushed into particles with a diameter of 0.2-2.5 mm.

5. The preparation method as claimed in claim 1, wherein the sodium silicate solution is adjusted to a modulus of 0.5 by using NaOH.

6. The preparation method as claimed in claim 1, wherein the ultrasonic conditions are achieved by inserting an ultrasonic vibration rod into the resulting mixture that has been stirred, a power of the ultrasonic vibration rod set as 200-400w, and reacting for 30-35 minutes under an ultrasound action thereof.

7. The preparation method as claimed in claim 1, wherein during injecting the slurry into the mold, when a volume of the slurry that has been injected is one-third of a volume of the mold of the lawn brick, performing compacting on the slurry that has been injected, and then the slurry is poured into the mold and compacted again to obtain a homogeneous green brick.

8. The preparation method as claimed in claim 1, wherein the step of curing the homogeneous green brick is to seal the mold that has been filled with the slurry and compacted through a cling film, and then placed at a constant temperature of 40° C. for curing for 24-48 hours.

9. The preparation method as claimed in claim 8, wherein the step of curing the homogeneous green brick further comprises: removing the brick from the mold and continue curing for 20 days at a temperature greater than 15° C. to maintain moisture thereof; when the temperature is less than 15° C., placing into a curing box or taking heat preservation measures thereof.

10. A lawn brick capable of solidifying and stabilizing lead-contaminated soil, wherein the lawn brick is prepared using raw materials in the following weight ratios:
3 parts of carbonized bagasse, 30-35 parts of heavily-lead-contaminated soil, 5-10 parts of construction waste, 54-60 parts of fly ash, and 50-55 parts of sodium silicate.
